(19) United States
(12) Patent Application Publication
(10) Pub. No.: US 2014/0318144 A1
(43) Pub. Date: Oct. 30, 2014

(54) DEVICE AND METHOD FOR SLOW TURNING OF AN AERODERIVATIVE GAS TURBINE

(71) Applicant: NUOVO PIGNONE S.P.A., Florence (IT)

(72) Inventors: Marco Lazzeri, Firenze (IT); Roberto Merlo, Firenze (IT); Filippo Viti, Firenze (IT); Antonio Baldassarre, Firenze (IT)

(73) Assignee: NUOVO PIGNONE S.P.A., Firenze (IT)

(21) Appl. No.: 14/358,181

(22) PCT Filed: Nov. 13, 2012
(86) PCT No.: PCT/EP2012/072442

§ 371 Date: May 14, 2014

(30) Foreign Application Priority Data
Nov. 14, 2011 (IT) FI2011A000247

(51) Int. Cl. F02C 7/32; F02C 9/00

(52) U.S. Cl. CPC F02C 7/32; F02C 9/00
USPC 60/772; 60/801

(57) ABSTRACT

An aeroderivative gas turbine, including a gas generator, a gas generator rotor, a power turbine section, and a slow turning device, wherein said slow turning device is designed and arranged to keep said rotor in rotary motion after turbine shut-down.

### FIELD OF THE INVENTION

Embodiments of the present invention relate generally to gas turbines and in particular to aeroderivative gas turbines.

### DESCRIPTION OF THE RELATED ART

Aeroderivative gas turbines are widely used as power sources for mechanical drive applications, as well as in power generation for industrial plants, pipelines, offshore platforms, LNG applications and the like.

The gas turbine can be subject to shut-down, e.g. in emergency situations and restarted after a short period of time. When the rotor of the turbine is left motionless following shutdown, thermal deformations can occur with reduction or elimination of clearances between rotoric and statoric parts, leading to rubbing between rotor and stator parts or rising up to appearance of rotor locking phenomena. Thermal deformations are related to not uniform temperature fields, due to several reasons. Cooling of the rotor when the turbine is motionless is not-uniform, the upper part of the rotor cools down slower than the lower part, due to natural convection phenomena, generating rotor bending and bowing deformation. Reduction of clearances between stator and rotor can also arise from temperature spreads related to secondary flow distribution during shut down. The turbine cannot be restarted until the rotor has reached the proper temperature field and geometry. Under this respect, the most critical parts of the aeroderivative gas turbine are the blade tips of compressor stages, where a limited clearance is provided between the stator and the rotor.

For some types of gas turbine-emergency shut down the cooling down process requires quite a long time, during which the turbine and the machinery driven thereby cannot be put into operation. This can cause substantial economical losses and/or raise technical or managing problems.

It has been suggested to solve this problem by keeping the turbine rotor revolving under slow turning condition during the shut-down period, thus avoiding non-uniform cooling down of the rotor and preventing the latter to lock. This is usually done by driving the turbine rotor into rotation by means of the start-up electric motor. The start-up electric motor requires a large amount of electric energy to be driven. For some particular plant emergency shutdown, no AC current is available and so no start-up motor or any high energy consumption utility can be used.

### SUMMARY OF THE INVENTION

Embodiments of the disclosure include an aeroderivative gas turbine with a slow-turning device, which is driven by a very low power consumption motor that can be electrically powered by means of an electric power source of limited capacity, e.g. by means of batteries. This allows keeping the gas generator rotor of the gas turbine in rotation when the gas turbine is shut down, preventing locking of the rotor and thus allowing immediate re-start of the turbine as soon as this becomes feasible.

According to an embodiment of the subject matter disclosed herein, an aeroderivative gas turbine is provided, comprising: a gas generator with a gas generator rotor and relevant casings; a power turbine section with a power turbine rotor and relevant casing; and a slow turning device selectively engaged with said gas generator rotor.

In some embodiments, the gas generator includes an axial compressor, combustors, a high pressure turbine and relative casings, shaft, bearings etc. The compressor rotor and the high pressure turbine rotor form together the gas generator rotor-having a common shaft, supported by end bearings in a casing. The slow turning device is designed and arranged to keep the gas generator rotor in rotary motion after turbine shut-down. The slow rotation of the gas generator rotor ensures that all the portions of the rotor cool down in a substantially uniform manner, thus avoiding locking of the rotor.

In some embodiments the power turbine is mechanically independent of the gas generator, i.e. the rotor of the power turbine section and the gas generator rotor are arranged in line. Combustion gases partially expand in the high pressure turbine and power the compressor of the gas generator. The combustion gases flowing out of the high pressure turbine are then further expanded in the power turbine to provide mechanical power driving into rotation the axis of the power turbine and the load connected thereto. The entire power extracted from the gases expanding in the power turbine is therefore used to drive the load.

In some embodiments the aeroderivative turbine includes a first compressor and a second compressor in series, air partially pressurized by the first compressor being further compressed in the second compressor. These gas turbines further include a high pressure turbine and a power turbine in series. The rotor of the high pressure turbine and the rotor of the second compressor form a gas generator rotor. The rotor of the power turbine is supported by a rotary shaft which extends coaxially to the gas generator rotor and drives into rotation the first compressor. Expansion of the combustion gases in the high pressure turbine generates mechanical power to drive the second compressor; further expansion of the combustion gases in the power turbine generates mechanical power to drive the first compressor and the load connected to the power turbine.

In both arrangements, a slow turning device can be provided such that, upon shut down of the gas turbine, the gas generator rotor is driven into rotation at slow speed by the slow turning device.

In some embodiments, the slow turning device is connected to a port of an auxiliary gear box of the gas turbine. More specifically, according to some embodiments, the slow turning device is connected to one of the ports of the auxiliary gear box which is provided for aeronautic applications of the turbine, but which remains unused when the turbine is used as an aeroderivative turbine for industrial applications, e.g. for power generation, mechanical drive or the like. In some embodiments the slow turning device is connected to the fuel pump port of the auxiliary gear box.

The subject matter disclosed herein therefore also concerns an aeroderivative gas turbine, with a gas generator and a gas generator rotor, further comprising an auxiliary gear box, a fuel pump port on said auxiliary gear box and a slow turning device connected to said fuel pump port.

In some embodiments the power turbine section comprises a power turbine with a limited number of expansion sections, e.g. from two to eight or six such sections, each section comprising a set of stationary blades supported by the turbine casing and a set of rotary blades, supported by the turbine rotor. The axial length of the power turbine rotor is therefore limited. A comparatively large clearance is provided between the rotary part and the stationary part of the power turbine. Both factors contribute to reducing the entity of any possible rotor bowing and mechanical interference between the rotor and the stator in the power turbine section. Slow turning of the power turbine rotor is therefore normally not necessary.

A further subject matter disclosed herein is a slow turning device for gas turbine rotor turning after emergency shut down, comprising an actuating device, such as e.g. an electric motor, a gearbox and a movable output shaft, which is torsionally constrained to a slow-speed output member of the gearbox, the movable output shaft being selectively movable between an operative position and an inoperative position. The movable output shaft can be a sliding output shaft.

According to a further aspect, a method for limiting locking of a rotor in an aeroderivative gas turbine upon shut down is provided, the gas turbine including a gas generator with a gas generator rotor and a power turbine, said method comprising the steps of: at shut down, mechanically connecting the gas generator rotor to a slow turning device, and rotating the gas generator rotor at a slow speed by means of the slow turning device during cooling off of the gas generator rotor until the turbine is re-started or until the gas generator rotor has cooled down to a determined temperature.

A slow turning speed is usually below 150 rpm, and more particularly lower than 100 rpm. In some embodiments the method provides the step of connecting said slow turning device to a fuel pump port of an auxiliary gear box of said aeroderivative gas turbine, said port being connected to the gas generator rotor of the aeroderivative gas turbine.

Features and embodiments are disclosed here below and are further set forth in the appended claims, which form an integral part of the present description. The above brief description sets forth features of the various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the present invention and many of the attendant advantages thereof will be readily obtained as the same becomes better understood by reference to the following detailed description when considered in connection with the accompanying drawings, wherein:

FIG. 1 illustrates a diagrammatic side view and partial sectional view of an aeroderivative gas turbine combined to a generic operating machine, such as e.g. a compressor or a compressor train;

FIG. 2 illustrates a sectional view of the aeroderivative gas turbine of FIG. 1;

FIG. 3 illustrates a perspective view of the auxiliary gear box of the gas turbine and combined slow turning device attached thereto in one embodiment;

FIG. 4 illustrates a side view and partial sectional view of the slow turning device in one embodiment;

FIG. 5 illustrates a perspective view of a component of the slow turning device;

FIG. 6 illustrates a section along line VI-VI of FIG. 5;

FIG. 7 illustrates a cross section of a slow turning device in a further embodiment; and

FIGS. 8, 9, and 10 schematically illustrate possible further embodiments of aeroderivative gas turbines provided with a slow turning device according to the subject matter disclosed herein.

### DETAILED DESCRIPTION OF EMBODIMENTS OF THE INVENTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

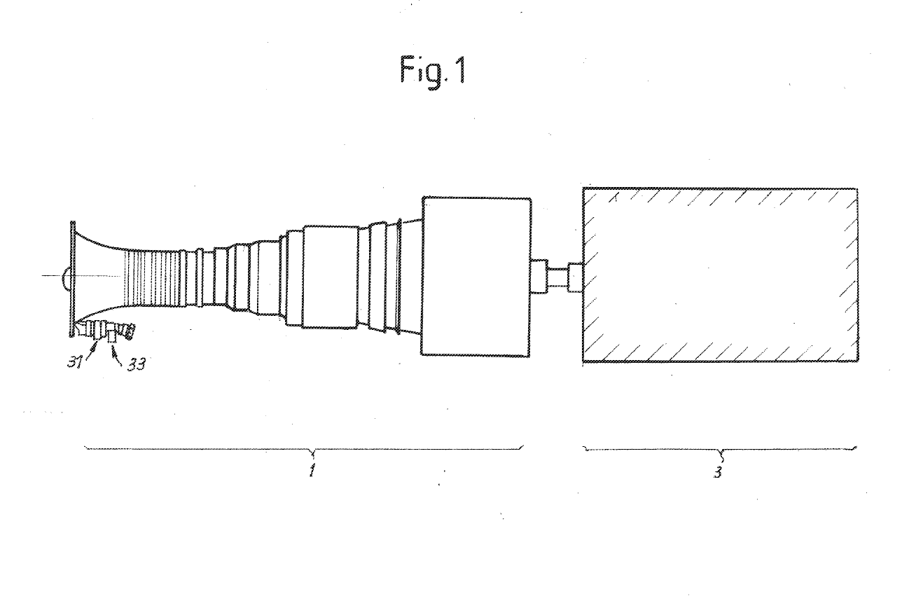

FIG. 1 illustrates, in an exemplary embodiment, an aeroderivative gas turbine 1 arranged to power an operating machine 3, e.g. an electric generator, a centrifugal compressor or any other load. The centrifugal compressor 3 can be a refrigerating gas compressor for a gas liquefaction system or any other machine requiring mechanical power from the aeroderivative gas turbine 1 to be driven. In some embodiments, a start-up motor is also provided, e.g. an electric motor, a hydraulic motor, a pneumatic motor or the like, to start-up the aeroderivative gas turbine 1 that will drive the machine 3.

In some embodiments the aeroderivative gas turbine 1 comprises a start-up hydraulic motor 1A (powered by a pump and an electric motor, not shown) arranged on the auxiliary gear-box below the cold end of the turbine.

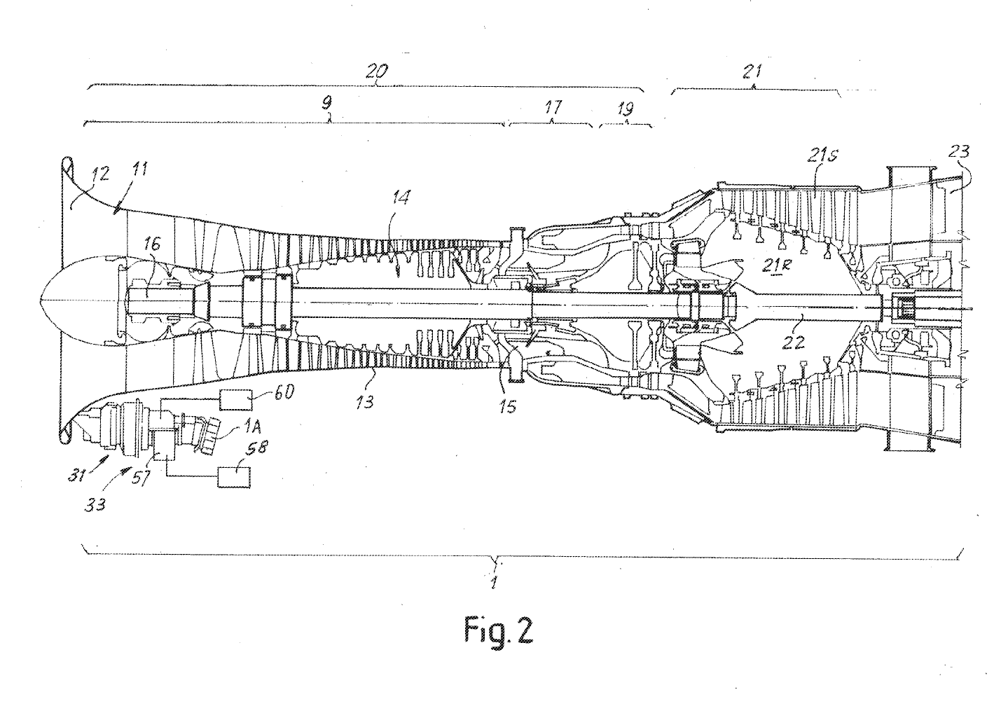

Referring now to FIG. 2, in some embodiments the aeroderivative gas turbine 1 includes a compressor section 9, including a compressor front frame or bell mouth 11, with an inlet, a casing 13 and a rotor 14 rotatingly supported on a shaft 16 and arranged in the casing 13. Rotary blades on the compressor rotor 14 and stationary blades on the casing 13 cause air to be sucked through the bell mouth 11, compressed and fed to an outlet 15 of the compressor section 9. The outlet 15 is in fluid communication with a combustor 17. Compressed air exiting the compressor section 9 is fed in the combustor 17 together with a gaseous or liquid fuel.

The combustor 17 is in fluid communication with a high pressure turbine 19. The high pressure turbine 19 is driven into rotation by the combustion gases flowing there through and provides power to drive the compressor section 9. Only part of the power available is used by the high pressure turbine 19 to drive the compressor. Hot gases exiting the high pressure turbine 19 are still pressurized and will be used in a downstream section of the aeroderivative gas turbine to generate mechanical power. The combination of compressor section 9, combustor 17 and high pressure turbine 19 is usually named gas generator and is designated 20 as a whole in the drawing.

The rotor 14 of the compressor section 9 and the rotor of the high pressure turbine 19 are arranged on a common shaft 16 and jointly form a gas generator rotor.

The gas generated by gas generator 20 and exiting the high pressure turbine 19 flows through a power turbine section downstream, wherein the energy contained in the gas is partly transformed in mechanical energy.

In the exemplary embodiment shown in the drawings, the power turbine section comprises a low pressure power turbine 21, comprising a stator 21S and a rotor 21R. In the embodiment illustrated in the drawings, the rotor 21R of the power turbine 21 is supported on a turbine shaft 22 and torsionally connected thereto, said turbine shaft 22 being mechanically separated from the shaft 16 of the gas generator.

The power turbine 21 can include a variable number of expansion stages. The exemplary embodiment illustrated in FIG. 2 includes a low speed, six-stages power turbine. Other embodiments can include a high speed power turbine, e.g. a high speed, two-stages power turbine. Exhaust gases exiting the power turbine at 23 can be used for co-generation purposes or simply discharged in the atmosphere.

The aeroderivative gas turbine can be a LM2500+G4 LSPT or LM2500 aeroderivative gas turbine, both commercially available from GE Aviation, Evendale, Ohio, USA. In other embodiments the aeroderivative gas turbine can be a PGT25+G4 aeroderivative gas turbine commercially available from GE Oil and Gas, Florence, Italy, or a Dresser-Rand Vectra® 40G4 aeroderivative gas turbine commercially available from Dresser-Rand Company, Houston, Tex., USA, for example. In other embodiments, the aeroderivative gas turbine can be a PGT25+, a PGT16, a PGT 20, all commercially available from GE Oil and Gas, Florence, Italy or an LM6000 aeroderivative gas turbine, commercially available from GE Aviation, Evendale, Ohio, USA.

In some embodiments the aeroderivative gas turbine shaft can drive the machine 3 directly, i.e. with a direct mechanical connection, such that the machine 3 rotates at the same speed as the power turbine section of the aeroderivative gas turbine. In other embodiments a gearbox can be arranged between the shaft of the power turbine and the shaft of the machine 3. The particular arrangement depends on design considerations, based on the kind of power turbine used (high speed or low speed) and/or on the rotary speed of the machine 3.

In some embodiments the aeroderivative gas turbine includes an auxiliary gearbox 31, sometimes named also accessory gearbox (AGB) 31. In the exemplary embodiment shown the auxiliary gear box 31 is arranged at the cold end of the gas turbine, and more specifically below the compressor front frame 11 of the gas generator 20. The auxiliary gear box 31 is connected to the shaft 16 of the gas generator 20 by means of a series of gears, not shown. In the embodiment shown the start-up hydraulic motor 1A is connected to the auxiliary gear box 31.

In aviation applications the turbine is used as a jet engine and is powered with liquid fuel. The liquid fuel is usually fed by a fuel pump driven via an output gear arranged in the auxiliary gearbox 31 and rotated by the shaft 16. The auxiliary gear box is provided with a fuel pump port, for connection of the fuel pump. The rotation of the gas generator rotor is thus transmitted to the fuel pump. This ensures continuity of the flow of fuel towards the combustor, to keep the turbine continuously running When the turbine is used as an aeroderivative turbine for industrial applications, the port of the auxiliary gearbox 31 provided for driving the fuel pump remains unused and is sealingly closed by a cover. In the Installation Design Manual (IDM) of the LM2500 gas turbine, for example, such port is named A17 port.

According to some embodiments, a slow turning device 33 for rotating the aeroderivative gas turbine, while cooling after shut-down, is combined to the auxiliary gearbox 31 and specifically to the port usually provided for driving the fuel pump.

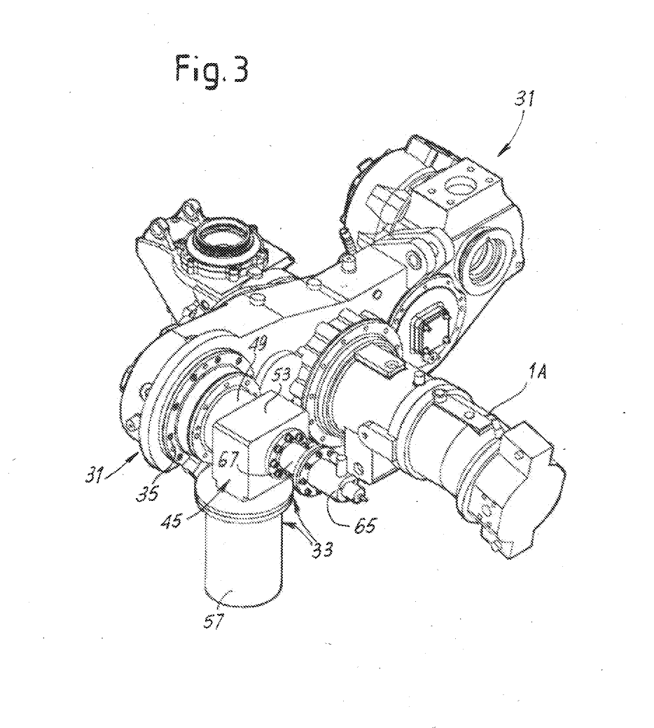

An embodiment of the slow turning device 33 will now be described referring to FIGS. 3 to 6. Reference 35 indicates the port of the auxiliary gearbox 31 to which the slow turning device 33 is connected. The auxiliary port 35 comprises a machined hollow shaft 37 torsionally coupled to a gear 39. As mentioned, a motion transmission arrangement, e.g. a set of toothed wheels, not shown, is provided between the shaft 16 of the gas generator and the gear 39.

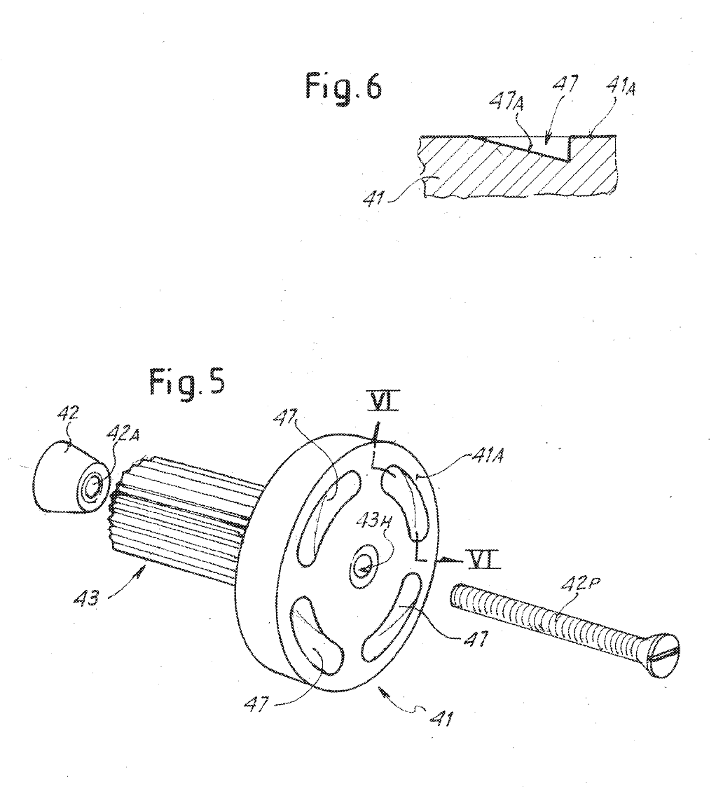

In the embodiment illustrated in the drawings, the slow turning device 33 comprises a flange 41 torsionally coupled to the internally machined hollow shaft 37 of the port 35. In some embodiments the flange 41 is torsionally and axially connected to the internally splined hollow shaft 37 by means of an externally splined shaft 43 and a locking mechanism. In some embodiments the locking mechanism comprises an internal expander 42, which can be frustum shaped. The internal expander 42 has a central threaded hole 42H engaging a threaded pin 42P. As shown in FIG. 5, the internal expander 42 and the pin 42P are introduced from opposite sides in a through hole 43H of the externally splined shaft 43. The inner diameter of the hole 43H is smaller than the maximum diameter of the internal expander 42, such that traction of the internal expander by means of the threaded pin 42P causes a radial expansion of the externally splined shaft 43, said expansion being facilitated by longitudinal slits machined in the externally splined shaft 43. In the embodiment illustrated in the drawings the externally splined shaft 43 is integrally formed with the flange 41. In other embodiments, not shown, the externally splined shaft 43 and the flange 41 can be made of two separately machined pieces and torsionally connected to one another thereafter.

The flange 41 comprises a clutch connection to a movable shaft 44 driven in rotation by an electric motor 57 through a gearbox 45. The shaft 44 is movable in order to engage or disengage the splined shaft 43. In some exemplary embodiments, the shaft 44 is provided with a sliding movement. Here below the movable shaft 44 will be therefore indicated also as sliding shaft 44.

In some embodiments the clutch connection comprises a plurality of arched slots 47. In the example shown four slots 47 are provided. The shape of the arched slots 47 can be best appreciated looking at FIG. 6, which illustrates a sectional view of one arched slot along line VI-VI in FIG. 5. Each arched slot 47 has an inclined bottom surface 47A, which extends from the front surface 41A of the flange 41 towards the interior of said flange. The inclined bottom surface 47A of each arched slot 47 forms a cam profile co-acting with a respective pin 49 for the purposes which will become clearer later on. The pins 49 project from a disc 51, which is in turn torsionally engaged to a first end of the sliding shaft 44 of the motor-driven gearbox 45.

The sliding shaft 44 is slidingly engaged in a sleeve 52 such as to be axially slidable but torsionally constrained to said sleeve, e.g. by means of a key-slot arrangement or a splined coupling. The sliding shaft 44 rotates integrally with sleeve 52 but can slide therein according to double arrow f44. The sleeve 52 is rotatingly supported in a housing 53 of the motor-driven gearbox 45. The sleeve 52 is driven into rotation by an electric motor 57. A gear-worm arrangement (not shown) transmits the rotary motion from the electric motor 57 to sleeve 52 with a suitable reduction ratio.

The motor-driven gearbox 45 and the sleeve 52 are connected to the auxiliary gear box 31. In some embodiments the motor-driven gearbox 45 is cantileverly constrained to the auxiliary gear box 31, a spacer 59 being arranged between the housing 53 and a cover 61 provided on port 35 and connected thereto.

The second end of the sliding shaft 44 extends outside the housing 53 of the reducer 55 towards an actuator 65. The actuator 65 is supported on the housing 53 via a hollow spacer 67, into which the second end of the sliding shaft 44 extends. The actuator 65 can be an electric actuator, an electro-magnetic actuator or any other actuator suitable to axially displace the sliding shaft 44 according to arrow f44 against the action of a resilient member acting as a locking device. In some embodiments the resilient member is a spring 69, e.g. a helical compression spring arranged between the sleeve 52, or an abutment integral thereto, and a shoulder 71 on the sliding shaft 44. The resilient member 69 urges the sliding shaft 44 in a disengagement position, i.e. in a position where the pins 49 are disengaged from the arched slots 47 of the flange 41.

The operation of the slow turning device 33 described so far is the following. When the aeroderivative gas turbine is operative, the actuator 65 is de-energized. The sliding shaft 44 is maintained in a non-engaged position by the resilient member 69, such that the pins 49 are out of engagement with respect to the auxiliary flange 41. The resilient member 69 therefore functions as a locking device, since it maintains the sliding shaft 44 and the disk 51 locked, i.e. forced in an out-of-engagement position with respect to the flange 41.

Upon shut-down of the aeroderivative turbine, the slow turning device 33 is activated. The actuator 65 is energized and pushes the sliding shaft 44 according to arrow f44 towards the port 35 such that the pins 49 engage the arched slots 47. The cam profiles formed by the inclined bottom surfaces 47A of the arched slots 47 facilitates mutual engagement of pins 49 and slots 47. The motor 57 is started and drives into rotation the gear 39 via sleeve 52, shaft 44, pins 49, flange 41 and the externally splined shaft 43. Rotary motion is transmitted to the shaft 16 of the gas generator 20, such that the latter is maintained in slow rotation. The gas generator rotor, including the rotor of the compressor 14 and the rotor of the high pressure turbine 19 is thus maintained in slow rotation, until the turbine is started again, or until the temperature of the machine has achieved such a profile that bowing of the rotor due to differential temperature between the upper part and the lower part becomes negligible.

The actuator 65 can be de-energized once slow rotation of the turbine by means of the motor 57 has started, in order to reduce energy consumption. Suitable means can be provided to prevent the resilient member 69 from disengaging the pins 49 from the arched slots. This can be achieved e.g. by means of a suitable friction force or by shaping the pins and the side walls of the arched slots 47 accordingly.

Aeroderivative gas turbines are relatively light machines. If a suitable reduction ratio through reducer 55 is provided, the shaft 16 of the gas generator 20 can be kept rotating at a slow speed by a low power electric motor 57. In some embodiments, a rotation speed of between 0.1 and 150 rpm can be achieved and maintained with a relatively small electric motor, having a power of e.g. between 0.1 and 1.5 kW and, more particularly, below 1.0 kW. In some embodiments, rpm values range between 10 and 50 rpm, e.g. between 18 and 30 rpm, using an electric motor 57 having a rated power of between 0.1 and 1.5 kW, for example, between 0.3 and 1.0 kW, and, more particularly, between 0.3 and 0.6 kW. It shall be understood that the above mentioned numerical values are given by way of example only and shall not be considered limitative.

The electric motor 57 can thus be powered by an emergency electric energy source, such as a battery or other devices, even when no grid power is available. An emergency electric energy source is schematically shown at 58 in FIG. 2.

A slow turning speed for the rotor of the gas generator 20 suffices to reduce bowing and avoid locking of the rotor due to differential temperatures between the upper and the lower portion of the rotor, both in the high pressure turbine section as well as in the axial compressor section 9. When the turbine is re-started, the cam profiles formed by the inclined bottom surfaces 47A of the arched slots 47 automatically disengage the sliding shaft 44 from the flange 41 once the rotary speed of the splined shaft 43 exceeds the speed of the sliding shaft 44. The electric motor 57 can be stopped. The resilient member 69 assists the back movement of the sliding shaft 44 and acts as a locking device preventing accidental re-engagement of the slow turning device 33 once the turbine has re-started. Damage of the slow turning device 33 is thus avoided.

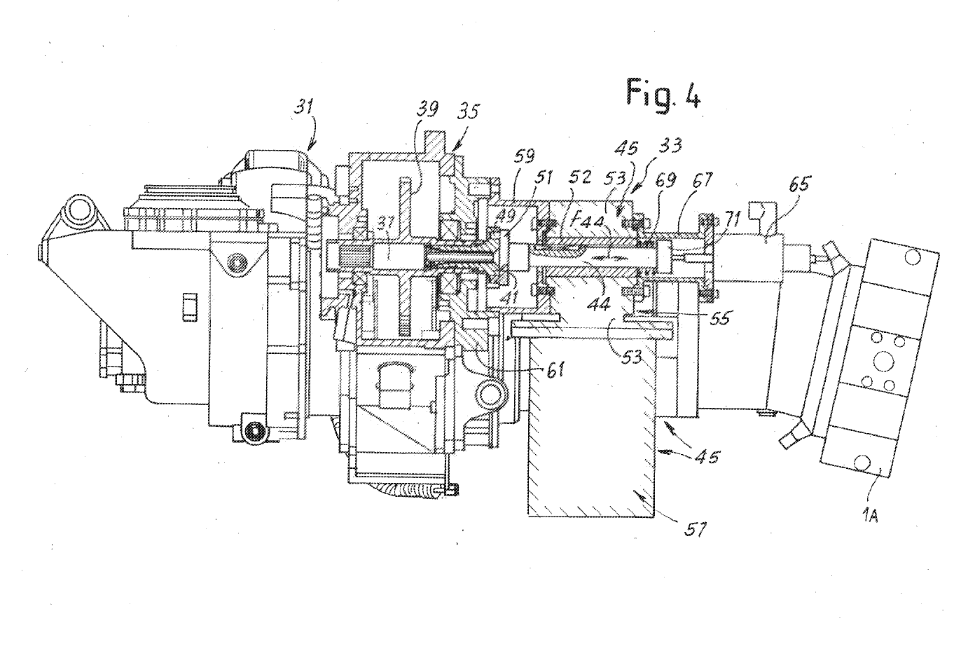

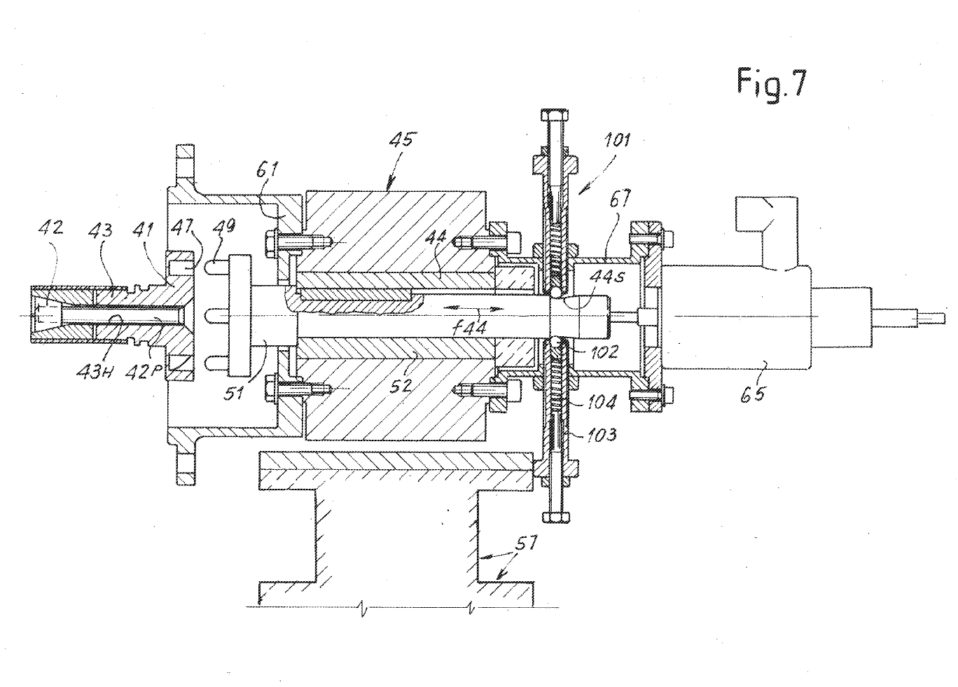

FIG. 7 shows a cross section of a slow turning device 33 in a modified embodiment. The same reference numbers designate the same or similar components as in FIG. 4. In this embodiment the sliding shaft 44 is locked in the disengaged position, illustrated in the figure, by means of a locking device 101. The locking device 101 comprises a plurality of spherical elements 102 projecting in an annular seat 44S formed in the sliding shaft 44. Each spherical element 102 is partly housed in a hollow pin 103 and projects therefrom into the annular seat 44S. A helical spring 104 is housed in each pin 103 and is resiliently biases the spherical element 102 in the radial direction to maintain said spherical element 102 engaged in the annular seat 44S.

The annular seat 44S is shaped with an approximately radial abutment wall and a sloping, approximately conical wall, extending from the radial abutment wall towards the actuator 65. The arrangement is such that the thrust exerted by the springs 104 via the spherical elements 102 maintains the sliding shaft 44 in the disengaged position, until the actuator 65 provides a sufficient axial thrust to overcome the force of the springs 104 causing the spherical elements 102 to roll along the conical wall of the annular seat 44S while the sliding shaft 44 is moved towards the flange 41 in the engaged position, when slow rolling of the turbine is required. Once the sliding shaft 44 has approached the flange 41 and the pins 49 are engaged in the arched slots 47, the spherical elements 102 contact the cylindrical outer surface portion of the sliding shaft 44, such that the springs 104 do not generate any axial force on the sliding shaft 44 anymore. The actuator 65 can be de-energized.

When the gas turbine is started again after a period of slow turning, the sliding shaft 44 is returned in the disengaged locked position shown in FIG. 7 by the combined action of the inclined bottom surfaces 47A of the arched slots 47 acting on the pins 49 and by the radial forces of the springs 104 acting on the spherical elements 102. The pins 49 are firstly pushed out of the arched slots 47 by the axial thrust exerted by the inclined bottom surfaces 47A of the arched slots due to the rotary speed of the splined shaft 43 exceeding the rotary speed of the sliding shaft 44. The axial back movement of the sliding shaft 44 causes the spherical elements 102 to engage the inclined conical surface of slot 44S again. The radial thrust exerted by the springs 104 thus move the sliding shaft 44 further back until the final withdrawal position of FIG. 7 is reached again. The locking device 101 then retains the sliding shaft 44 in the withdrawn position until the actuator 69 is energized again.

In some embodiments a safety control can be provided, in order to block the slow turning of the turbine, should the rotating gas generator rotor 20 touch the casing generating a resisting torque, e.g. should the tips of the compressor blades scrape against the inner surface of the compressor casing.

In some exemplary embodiments this safety control is provided mechanically by a clutch between the slow turning motor 57 and the gas rotor shaft 20, e.g. between the slow turning motor 57 and the sliding shaft 44.

In other embodiments, in combination or as an alternative to the mechanical control, an electronic control can be provided. One way of electronically controlling and stopping the slow turning of the turbine is by controlling the power absorbed by the electric motor 57. In some embodiments a control unit, schematically shown in FIG. 2 and labeled 60, and a current sensor (not shown) can be provided. The current sensor provides a signal proportional to the current absorbed by the motor 57. Said current is proportional to the power absorbed by the motor. The a value proportional to the detected current can be compared with a threshold value and the electric motor 57 can be de-energized, thus stopping slow turning of the turbine, should the current threshold be exceeded.

This increases the operation safety of the slow turning device.

The gas turbine described herein above comprises a compressor, a high pressure turbine drivingly connected to said compressor by means of a first shaft, and a power turbine supported by a second shaft, independent of said first shaft, i.e. the gas generator shaft. Other aeroderivative gas turbine arrangements can be used in combination with a slow turning device as described here above.

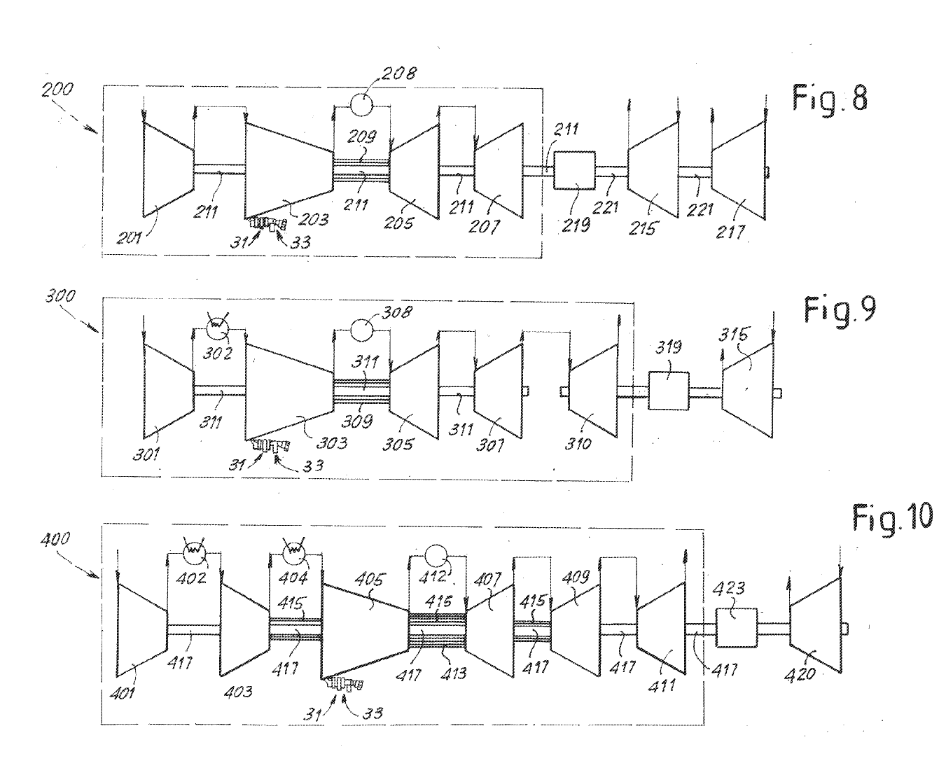

FIG. 8 schematically illustrates an aeroderivative gas turbine 200, comprised of the following, sequentially arranged turbo-machines in fluid communication one to the other: a low pressure compressor 201, a high pressure compressor 203, a high pressure turbine 205, a low pressure turbine 207. Fresh air is first compressed to an intermediate pressure in the low pressure compressor 201 and delivered to the high pressure compressor 203 which compresses the air at the final pressure. Fuel is added to the compressed air flow delivered by the high pressure compressor 203 in a combustion chamber 208. Combustion gases at high pressure and high temperature from the combustion chamber 208 are sequentially expanded in the high pressure turbine 205 and in the low pressure turbine 207. The high pressure turbine 207 is mechanically connected via a first shaft 209 to the high pressure compressor 203. The mechanical power generated by gas expansion in the high pressure turbine 205 is used to drive the high pressure compressor 203. A second shaft 211 extends coaxially through the first shaft 209 and mechanically connects the low pressure compressor 201 and the low pressure turbine 207. The mechanical power generated by the gas expansion in the low pressure turbine 207 is partly used to rotate the low pressure compressor 211. The exceeding power is used to drive a load 215, 217. In the embodiment shown the second shaft 211 is mechanically connected to the load 215, 217 via a gearbox 219. The load 215, 217 can be formed e.g. by a compressor train comprising a first compressor 215 and a second compressor 217, rotated by a driven shaft 221.

An auxiliary gear box 31 is provided at the cold end of the high pressure compressor 203. Said auxiliary gear box 31 comprises a fuel pump driving port, intended to drive a liquid fuel pump. When the gas turbine is used for industrial applications, as in the embodiment shown in FIG. 8, the fuel pump port of the auxiliary gear box 31 is used for connecting a slow turning device 33. The slow turning device 33 can be designed as described here above, with reference to FIGS. 3 to 7. The slow turning device 33 maintains under slow-speed turning conditions the gas generator rotor comprised of the high speed compressor 203, the shaft 209 and the high pressure turbine 205.

FIG. 9 illustrates a further embodiment of a gas turbine layout including a slow turning device 33. In the embodiment of FIG. 9 the gas turbine 300 comprises the following, sequentially arranged turbo-machines in fluid communication one to the other: a low pressure compressor 301, a high pressure compressor 303, a high pressure turbine 305, a first low pressure turbine 307 and a second low pressure turbine 310. Fresh air is compressed in the low pressure compressor 301, cooled in an intercooler 302 and delivered to the high pressure compressor 303 for final compression before being fed to a combustion chamber 308, where fuel is added to the compressed air flow. Combustion gases at high pressure and high temperature from the combustion chamber 308 are sequentially expanded in the high pressure turbine 305, in the first low pressure turbine 307 and in the second low pressure turbine 310. The high pressure turbine 307 is mechanically connected via a first shaft 309 to the high pressure compressor 303. The mechanical power generated by gas expansion in the high pressure turbine 305 is used to drive the high pressure compressor 303. A second shaft 311 extends coaxially through the first shaft 309 and mechanically connects the low pressure compressor 201 and the first low pressure turbine 307. The mechanical power generated by the gas expansion in the first low pressure turbine 307 is used to rotate the low pressure compressor 311. The combustion gases from the first low pressure turbine 307 are further expanded in the second low pressure turbine 310, whose shaft 311 is mechanically separated from the second shaft 311 and drives the load 315. If the rotary speed of the second low pressure turbine 310 is different from the rotary speed of the load 315, a gearbox 319 can be interposed between said two turbo-machines.

An auxiliary gear box 31 is provided at the cold end of the high pressure compressor 303 and a slow turning device 33 is connected to a port of the auxiliary gear box 31, e.g. the port provided to drive the liquid fuel pump. The slow turning device 33 can be designed as described here above, with reference to FIGS. 3 to 7. When operating, the slow turning device 33 maintains the gas generator rotor in slow rotation conditions, said gas generator rotor being comprised of the first shaft 309, the high pressure compressor 303 and the high pressure turbine 305.

FIG. 10 illustrates a further embodiment of a gas turbine layout including a slow turning device 33. In the embodiment of FIG. 10 the gas turbine 400 comprises the following, sequentially arranged turbo-machines in fluid communication one to the other: a first low pressure compressor 401, a second low pressure compressor 403, a high pressure compressor 405, a high pressure turbine 407, a first low pressure turbine 409 and a second low pressure turbine 411. Fresh air is sequentially compressed in a three-stage compression process by the three compressors 401, 403, 405. Intercoolers 402, 404 can be provided between the first low pressure compressor 401 and the second low pressure compressor 403 and between the second low pressure compressor 403 and the high pressure compressor 405, respectively. Fuel is mixed to the compressed air in a combustion chamber 412 and the resulting combustion gas is sequentially expanded in the high pressure turbine 407 and in the two low pressure turbines 409, 411. The power recovered by gas expansion in the high pressure turbine 407 is used to drive the high pressure compressor 405 via a first shaft 413. A second shaft 415 connects the first low pressure turbine 409 to the second low pressure compressor 403 and extends coaxially inside the first shaft 413. The power recovered by the expansion of the combustion gases in the first low pressure turbine is thus used to rotate the second low pressure compressor 403. The second low pressure turbine is mechanically connected through a third shaft 417 to the first low pressure compressor 401. A part of the mechanical power recovered by the second low pressure turbine 414 is used to rotate the first low pressure compressor 401. The remaining power on shaft 417 is used to drive a load 420. A gearbox 423 can be provided between the third shaft 417 and the load 420, if the latter is to be rotated at a rotary speed different from the speed of the second low pressure turbine 414.

An auxiliary gear box 31 is provided at the cold end of the high pressure compressor 405 and a slow turning device 33 is connected to a port of the auxiliary gear box 31, e.g. the port provided to drive the liquid fuel pump. The slow turning device 33 can be designed as described here above, with reference to FIGS. 3 to 7. The gas generator rotor is comprised of the first shaft 413, the high pressure compressor 405 and the high pressure turbine 407 and is maintained in rotation by the slow turning device 33 after turbine shut-down.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. An aeroderivative gas turbine comprising:
a gas generator;
a gas generator rotor;
a power turbine section; and
a slow turning device,
wherein the slow turning device is configured to keep the gas generator rotor in rotary motion after the aeroderivative gas turbine is shutdown.

2. The aeroderivative gas turbine according to claim 1, further comprising an auxiliary gear box, wherein the slow turning device is selectively engageable to and disengageable from the auxiliary gear box.

3. The aeroderivative gas turbine according to claim 2, wherein the slow turning device is selectively engageable to and disengageable from a fuel pump port of the auxiliary gear box.

4. The aeroderivative gas turbine according to claim 2, wherein the auxiliary gear box is drivingly connected to the gas generator rotor.

5. The aeroderivative gas turbine according to claim 1, further comprising an auxiliary gear box comprising a hollow splined shaft, wherein a first clutch portion is rotatingly engaged to the hollow splined shaft, and wherein a second clutch portion is selectively connectable to and disconnectable from the first clutch portion.

6. The aeroderivative gas turbine according to claim 5, wherein the first clutch portion comprises slots, and the second clutch portion comprises pins selectively engageable into the slots, or vice-versa.

7. The aeroderivative gas turbine according to claim 1, wherein the slow turning device comprises an actuator configured to selectively engage the slow turning device to the gas generator rotor.

8. The aeroderivative gas turbine according to claim 7, wherein the actuator is an electric actuator, and is configured to be energized when the aeroderivative gas turbine is shut down.

9. The aeroderivative gas turbine according to claim 1, wherein the slow turning device comprises an electric motor, a movable shaft, and a gearbox therebetween, the movable shaft being selectively movable between an operative position, in which the movable shaft is engaged to the gas generator rotor, and an inoperative position, in which the movable shaft is disengaged from the gas generator rotor.

10. The aeroderivative gas turbine according to claim 9, wherein the movable shaft is slidingly housed in a slow-speed output member of the gearbox of the slow turning device.

11. The aeroderivative gas turbine according to claim 10, wherein the movable shaft is retained in the inoperative position by a locking device, and wherein the electric actuator is configured to selectively move the movable shaft from the inoperative position to the operative position against the action of the locking device.

12. The aeroderivative gas turbine according to claim 1, further comprising an emergency energy source configured to power the slow turning device.

13. The aeroderivative gas turbine according to claim 12, wherein the emergency source comprises an electric accumulator.

14. The aeroderivative gas turbine according to claim 1, further comprising a control arrangement configured to deactivate the slow turning device if a resistive torque on the gas generator rotor exceeds a threshold value.

15. A slow turning device for turning a gas generator rotor of an aeroderivative gas turbine after shut down of the aeroderivative gas turbine, the slow turning device comprising:
an electric motor;
a gearbox; and
an movable shaft torsionally constrained to a slow-speed output member of the gearbox, wherein the movable shaft is selectively movable between an operative position and an inoperative position.

16. The slow turning device according to claim 15, wherein the movable shaft is slidingly housed in the slow-speed output member.

17. The slow turning device according to claim 15, further comprising:
a locking device configured to retain the movable shaft (44) in the inoperative position; and
an actuator configured to selectively move the movable shaft from the inoperative position to the operative position against the action of the locking device.

18. The slow turning device according to claim 15, comprising an emergency energy source to power the electric motor.

19. The slow turning device according to claim 18, wherein the emergency source comprises an electric accumulator.

20. The slow turning device according to claim 15, comprising a control arrangement to deactivate the slow turning device if a resistive torque on the gas generator rotor exceeds a threshold value.

21. A method for limiting or preventing locking of a gas generator rotor in an aeroderivative gas turbine upon shut down, the aeroderivative gas turbine including a gas generator with the gas generator rotor and a power turbine, the method comprising:
at shut down, mechanically connecting said the gas generator rotor to a slow turning device; and
rotating the gas generator rotor at a reduced speed by the slow turning device during cooling off of the gas generator rotor until the aeroderivative gas turbine is re-started or until the gas generator rotor has achieved a selected temperature condition.

22. The method according to claim 21, wherein the gas generator rotor is connected to the slow turning device (33) through an auxiliary gear box of the aeroderivative turbine.

23. The method according to claim 21, wherein the gas generator rotor is connected to the slow turning device through a fuel pump port of the aeroderivative turbine.

24. The method according to claim 21, comprising powering the slow turning device with an emergency energy power source.

25. The method according to claim 21, comprising powering the slow turning device with an emergency electric accumulator.

26. The method according to claim 21, wherein the gas generator rotor is maintained at a rotational speed below 150 rpm, during cooling off.

27. The method according to claim 21, further comprising:
stopping the rotation of the gas generator rotor if a resistive torque on the gas generator rotor exceeds a threshold torque value.

28. The method according to claim 27, comprising the steps of detecting a parameter proportional to an electric power absorbed by the slow turning device and stopping the slow turning device if the electric power exceeds a threshold.

29. The method according to claim 21, comprising the step of powering the slow turning device by electric energy emergency source.
